(19) United States
(12) Patent Application Publication
(10) Pub. No.: US 2014/0261856 A1
(43) Pub. Date: Sep. 18, 2014

(54) Mobile Self-Service Credit Card-Based Fueling Metering Platform and Method

(71) Applicant: Phillip Brooks, Dallas, TX (US)

(72) Inventor: Phillip Brooks, Dallas, TX (US)

(21) Appl. No.: 13/840,841

(22) Filed: Mar. 15, 2013

(51) Int. Cl. B67D 7/78; B67D 7/54

(52) U.S. Cl. CPC B67D 7/78; B67D 7/54
USPC 141/1; 141/85

(57) ABSTRACT

A portable self-serve fuel metering system that may be coupled to a standard portable storage tank or tanker truck, which eliminates for specialized equipment on the tank or tanker truck and the need for underground storage tanks. The invention provides a self-service mobile fueling metering system to be used in collaboration with a standard mobile fueling tank (e.g. a mobile fuel tank or tanker truck). The fuel would be accessible any time a user desires and would not require an attendant be present. The invention provides a cost effective and simple way to provide customers fuel at any time, in a location of your choosing. By using portable tanks or tanker trucks, the invention eliminates the possibility of environmental leaks and spills.

### RELATED APPLICATION DATA

Not applicable.

### TECHNICAL FIELD

The present invention relates in general to a system and method for providing a self-service mobile fueling system.

### BACKGROUND OF THE INVENTION

A typical fuel station has a permanent tank installed, either underground or above ground. These permanent tanks are positioned in a location, and delivery trucks periodically deliver and transfer fuel to the permanent tank. The cost to install one of those tanks can be very costly, and these types of tanks are not mobile. There is a need for a portable tank or tanker truck solution for use with a separate mobile metering system.

Underground tanks and large above-ground tanks are expensive and also not portable. Underground tanks are subject to leaks that cause severe environmental hazards by contamination of fuel, soil, ground water, and drinking water. Research shows many geographic areas had, and currently have, this environmental leakage problem. Thousands of leaking ground tanks have to be dug up because of potential contamination of the drinking water. There is a need for a more environmentally-friendly solution to the tank problem.

The U.S. Pat. No. 4,988,020 to Webb shows a fuel dispensing device. Despite its description, the storage tank shown in the '020 Webb Patent uses a stationary tank that is not mobile or easily movable. The storage tank in the '020 Webb Patent can only be moved by implementation of a crane or other lifting device, and this storage tank is not a standard portable tank or tanker truck. The mobility of the system disclosed in Webb Patent suffers by its lack of mobility. It would not be versatile nor economically feasible to transport a heavy concrete base and tank loaded with fuel over a long distance and heavily traveled highways, which makes the system in Webb non-portable in any conventional sense.

Above-ground fuel dispensing systems are known and illustrated, for example, by U.S. Pat. No. 7,296,601, as well as the U.S. Pat. No. 5,400,924 to Brodie, and Bryant, U.S. Pat. No. 5,114,046. These patented structures are not portable and are intended to remain at a specified location. There is a need for a mobile self-serve metering system that can be used with a mobile or movable tank or tanker truck.

U.S. Pat. Nos. 6,152,197 and 5,983,962, both to Geradot, disclose a specialized tanker truck system that has specialized metering and storage implemented integral with the tanker truck capabilities. Specialized truck or tank equipment is more expensive standard tanks and tanker trucks, and such specialized systems are not as versatile or portable as needed.

For instance, there is a need for an unattended self-serve system that does not require a gas station attendant and conventional credit cards can be used to pay from such fuel transfers. Self-service mobile metering systems at rural airports or at construction sites would allow purchasers the flexibility of purchasing fuel when it is convenient, and without incurring a late-night attendant service call charge.

The Rogers U.S. Pat. No. 4,131,214 shows a gasoline delivery truck which utilizes the air pressure associated with the vehicle air brakes to pressurize the area over the fuel for forcing fuel from the truck. This patented arrangement is for a delivery truck, not a retail dispensing device. There is a need for a mobile retail metering system that can be used with a conventional portable tank or tanker truck.

### SUMMARY OF THE INVENTION

Because specialized truck or tank equipment is more expensive than standard tanks and tanker trucks, the present invention is a portable self-serve metering and pumping system that can be used with standard mobile tanks or tanker trucks. A portable self-serve fuel metering system that may be coupled to a standard portable storage tank or tanker truck, which eliminates the need for specialized equipment on the tank or tanker truck and the need for underground storage tanks. By using portable tanks or tanker trucks, the invention eliminates the possibility of environmental leaks and spills. A primary purpose of the present invention is to aid in a cleaner environment, which is a more environmentally-friendly solution to the tank problem.

A self service mobile fueling system having a mobile fueling unit and a mobile fueling tank. The mobile fueling unit having a pump or dispenser is secured to a platform that allows the pump to be easily relocated, and supports self-service at the metering equipment, including the use of credit card payments. A tanker truck couples to the self-serve portable metering system in the present invention. When empty, a new tank or tanker truck can be driven to the location of the empty tank or tanker truck for swapping out.

This self-service mobile metering and pumping system can be used at rural airports or at construction sites, and thereby allows purchasers the flexibility of purchasing fuel when it is convenient to the purchaser and without incurring a late-night attendant service call charge. As such, this invention supports that use of a mobile self-serve retail metering system that can be used with a conventional portable tank or tanker truck.

### BRIEF DESCRIPTION OF THE DRAWINGS

FIG. 1 is a front view illustrating a self-service mobile fueling unit.

FIG. 2 is an assembly view of a self-service mobile fueling system.

FIG. 3 is a front view of an embodiment of the dispenser of a self-service mobile fueling system.

FIG. 4 is a top view of an embodiment of the dispenser of a self-service mobile fueling system.

FIG. 5 is a side view of an embodiment of the dispenser of a self-service mobile fueling system.

FIG. 6 is a bottom view of an embodiment of the dispenser of a self-service mobile fueling system.

FIG. 7 is an assembly view of a self-service mobile fueling system.

FIG. 8 is an assembly view of a self-service mobile fueling system.

### DETAILED DESCRIPTION

The scope of the invention provides a self-service mobile fueling metering system to be used in collaboration with a standard mobile fueling tank (e.g. a mobile fuel tank or tanker truck). The invention allows for a temporary self-serve station to be used that does not require the installation of a fuel tank (below or aboveground) or a fueling mechanism (e.g. a fuel pump). The fuel would be accessible any time a user desires and would not require an attendant be present.

The invention provides a cost effective and simple way to provide customers fuel at any time, in a location of your choosing. The invention is intended to be used at emergency evacuations, construction sites, small airports, speedways, or anywhere in need of a temporary and/or inexpensive self-service fueling station.

A system providing self-service mobile fueling is herein disclosed. The system comprises a self service mobile fueling unit and a mobile fuel tank. The mobile fuel tank is an aboveground tank that is easily moved from one location to another. Because specialized truck or tank equipment is more expensive than standard tanks and tanker trucks, the present invention is a portable self-serve metering system that can be used with standard mobile tanks or tanker trucks.

A portable self-serve fuel metering system that may be coupled to a standard portable storage tank or tanker truck, which eliminates the need for specialized equipment on the tank or standard tanker truck and the need for permanent storage tanks. By using portable tanks or tanker trucks, the invention eliminates the possibility of environmental leaks and spills. A primary purpose of the present invention is to aid in a cleaner environment, which is more environmentally-friendly solution to the tank problem.

In general, the present invention uses a method of fueling vehicles at selectable temporary locations including initially coupling a standard tank or tanker truck to the portable self-serve metering system. The standard tank or tanker truck can be temporary located in a secure manner at or near the portable self-serve metering system, and when empty the tank or tanker truck can be replaced with another tank or tanker truck filled with fuel.

A self service mobile fueling system having a mobile fueling unit and a mobile fueling tank. The mobile fueling unit having a pump or dispenser is secured to a platform that allows the pump to be easily relocated, and supports self-service at the metering equipment, including the use of credit card payments. A tanker truck couples to the self-serve portable metering system in the present invention. When empty, a new tank or tanker truck can be driven to the location of the empty tank or tanker truck for swapping out.

This self-service mobile metering systems can be used at rural airports or at construction sites, and thereby allow purchasers the flexibility of purchasing fuel when it is convenient to the purchaser and without incurring a late-night attendant service call charge. As such, this invention supports that use of a mobile self-serve retail metering system that can be used with a conventional portable tank or tanker truck.

In general, and in one form of the invention, an above ground portable fuel dispensing device includes a fuel container formed of inner and outer fuel impervious walls and a plurality of fuel metering and dispensing units coupled to the container for simultaneously dispensing metered quantities of fuel to a plurality of vehicles. A plurality of wheels such as the undercarriage of a semi-tractor trailer support the device for allowing the device to be moved between locations at which fuel is dispensed to vehicles and a fuel container refilling location.

For dispensing highly flammable fuels, an air compressor may be used to pressurize an air space in the fuel container for forcing fuel from the container to the vehicles. As an alternative, each dispensing unit may include a hydraulically powered pump for pumping fuel from the container to a vehicle and a common source of pressurized hydraulic fluid may be coupled by oil line 20 to each of the fuel metering and dispensing units for selectively dispensing fuel from the units.

FIG. 1 illustrates an embodiment of a self-service mobile fueling unit 100. In this embodiment, the fueling unit 100 comprises a dispenser or pump 101, a card reader 120, a filter 130, a fueling hose 145, a tank attachment apparatus (see FIG. 2) and a pallet or platform 102.

The pump 101 is secured to the platform 102. Preferably a hose reel or holder 140 is secured to the platform 102 to hold the fueling hose 145. A filter 130 is secured to the pump 101 and fueling hose 145 to filter any particles from the gas that may be harmful to the mechanism being fueled. Preferably each part is secured to another part by way of bolts, rivets, screws, welding, or any other forms of fastening. Filter 130 may also be integral to the pump 101.

By having the pump 101, card reader 120, hose reel 140, and filter 130 directly or indirectly secured to platform 102, the fueling unit 100 is easily mobile as the platform only needs to be moved from one location to another. The mobility of the fueling unit 100 allows it to be installed in various locations whether temporary, semi-permanent or permanent. Some examples of temporary locations may be a construction site, a fairground, or an event. Some semi-permanent or permanent locations may be a small charter airport, a marina, or a small rural town.

Card reader 120 allows the fueling unit 100 to be self-service. The self-service aspect of the invention is important as it allows the fueling unit 100 to be used anyway without a need for an attendant to be present. The card reader 120 may process transactions through a wired or wireless connection. A wireless connection may be a Wi-Fi connection through a local router or a network connection using cell towers and/or satellites. This purchasing means provides a user 24/7 access to the fuel. The card reader 120 may also be integral to pump 101 (see FIG. 3).

Further, fueling unit 100 comprises a tank attachment apparatus that is secured to pump 101. The tank attachment apparatus is used to connect and disconnect the mobile fueling tank to and from the fueling unit 100 and is further discussed in FIG. 2. The unit 100 controls the tanker venting system and integral controls.

Referring to FIG. 2, an assembly view of a self-service mobile fueling system is shown. The self-service mobile fueling unit 200 is shown along its side. In this embodiment, the fueling unit 200 comprises a dispenser or pump 201, a card reader 220, a filter 230, a fueling hose 245 and a pallet or platform 202.

The pump 201 is secured to the platform 202. Preferably a hose reel or holder 240 is secured to the platform 202 to hold the fueling hose 245. A filter 230 is secured to the pump 201 and fueling hose 245 to filter any particles from the gas that may be harmful to the mechanism being fueled. Preferably each part is secured to another part by way of bolts, rivets, screws, welding, or any other forms of fastening.

By having the pump 201, card reader 220, hose reel 240, and filter 230 directly or indirectly secured to platform 202, the fueling unit 200 becomes easily mobile as the platform 202 only needs to be moved from one location to another. The mobility of the fueling unit 200 allows it to be installed in various locations whether temporary, semi-permanent or permanent. Some examples of temporary locations may be a construction site, a fairground, or an event. Some semi-permanent or permanent locations may be a small charter airport, a marina, or a small rural town.

The platform 202 may be relocated by trailer, fork lift, cargo/freight, or any common means of transportation. The platform 201 may be simply placed in a location or temporarily secured to the ground by stakes, bolts, anchoring fasteners, or other forms of anchoring objects to the ground common in the art.

Card reader 220 allows the fueling unit 200 to be self-service. The self-service aspect of the invention is important as it allows the fueling unit 200 to be used anyway without a need for an attendant to be present. The card reader 220 may process transactions through a wired or wireless connection. A wireless connection may be a Wi-Fi connection through a local router or a network connection using cell towers and/or satellites. This purchasing means provides a user access to the fuel 24 hours a day, 7 days a week.

The fueling unit 200 is adapted to connect to a mobile fueling tank 205. The fueling unit 200 comprises a tank attachment apparatus 250 that is secured to pump 201. The tank attachment apparatus 250 is used to connect and disconnect the mobile fueling tank 205 to and from the fueling unit 200. The tank attachment apparatus 250 comprises a coupler 252. Mobile fueling tank 205 further comprises an adapter 254 that is adapted to couple with coupler 252, and has features to control standard transport and transfer vents and integral controls. Pump 201 may also comprise an emergency valve 280 to which tank attachment apparatus 250 is secured.

Preferably, the coupler 252 and adapter 254 are Dry Break or API couplings which are dry disconnect couplings or dry break couplers that form a secure hose connection and allow for a spill-free disconnect. Dry Break couplings have become standard use to prevent spillage of petro-chemicals during the connection and disconnection of flowlines. Other coupling pairs may be used provided that the coupler 252 and adapter 254 are secured together in a way that prevents spillage of petro-chemicals during the connection and disconnection of flowlines.

A mobile fueling tank 205 may be of a variety of mobile tanks including a mobile fuel tank, fuel trailers and fuel tankers. The mobile fueling tank 205 comprises a tank 210 that can hold a liquid. The mobile fueling tank 205 should be aboveground and not permanently secured to a location. Preferably, the mobile fueling tank 205 is a fuel tanker that can be easily connected and disconnected from the metering and pumping unit 200 as needed. When the fuel is low in the tank 210, the mobile fueling tank 205 is disconnected from the fueling unit 200, taken to a refueling location, refilled and returned to the fueling unit location and reconnected to the fueling unit 200 or replaced with another tanker unit.

Pump 201 may also comprise electrical outputs that connect the fueling unit 200 to a generator, electrical outlet, and/or electrical connectors on the mobile fueling tank.

FIGS. 3-6 illustrate an alternate embodiment of the fueling unit. Referring to FIG. 3, a front view of an embodiment of the dispenser of a self-service mobile fueling system is shown. This embodiment incorporates the card reader 320 into the dispenser or pump 301.

Referring to FIG. 4, a top view of an embodiment of the dispenser of a self-service mobile fueling system is shown. The top of pump 401 defines various holes to allow for connection electrical cables and connectors.

Referring to FIG. 5, a side view of an embodiment of the dispenser of a self-service mobile fueling system is shown. This embodiment of pump 501 further comprises a nozzle holder 560 and further defines a hose slot 547. The nozzle holder 560 is adapted to hold a nozzle that is secured to the hose. The nozzle holder 560 holds the nozzle when not in use, similar to a nozzle holder at a common gas station pump. Hose slot 547 allows a hose to pass through the wall of pump 501 if the hose is secured on the inside of pump 501.

Referring to FIG. 6, a bottom view of an embodiment of the dispenser of a self-service mobile fueling system is shown. This embodiment of the pump 601 includes a hose reel 640 inside pump 601. Pump 601 further defines a hose slot 647 in the side wall to allow hose 645 to extend out from hose reel 640 and pass through hose slot 647 to the outside of pump 601. Pump 601 further comprises a meter 671, a valve 672, and an inner nozzle 673. Meter 671 measures the flow through of liquid being dispensed. Valve 672 provides a liquid or fuel shut-off between the pump 601 and fuel source (i.e. fuel tank). Inner nozzle 673 helps regulate the flow speed of the liquid or fuel entering hose 645.

Referring to FIG. 7, an assembly view of a self-service mobile fueling system is shown. The self-service mobile fueling unit 700 is shown along its side. In this embodiment, the fueling unit 700 comprises a dispenser or pump 701, a card reader 720, a filter 730, a fueling hose 745 and a pallet or platform 702.

The pump 701 is secured to the platform 702. Preferably a hose reel or holder 740 is secured to the platform 702 to hold the fueling hose 745. A filter 730 is secured to the pump 701 and fueling hose 745 to filter any particles from the gas that may be harmful to the mechanism being fueled. Preferably each part is secured to another part by way of bolts, rivets, screws, welding, or any other forms of fastening.

By having the pump 701, card reader 720, hose reel 740, and filter 730 directly or indirectly secured to platform 702, the fueling unit 700 becomes easily mobile as the platform 702 only needs to be moved from one location to another. The mobility of the fueling unit 700 allows it to be installed in various locations whether temporary, semi-permanent or permanent. Some examples of temporary locations may be a construction site, a fairground, or an event. Some semi-permanent or permanent locations may be a small charter airport, a marina, or a small rural town.

The platform 702 may be relocated by trailer, fork lift, cargo/freight, or any common means of transportation. The platform 701 may be simply placed in a location or temporarily secured to the ground by stakes, bolts, anchoring fasteners, or other forms of anchoring objects to the ground common in the art.

Card reader 720 allows the fueling unit 700 to be self-service. The self-service aspect of the invention is important as it allows the fueling unit 700 to be used anyway without a need for an attendant to be present. The card reader 720 may process transactions through a wired or wireless connection. A wireless connection may be a Wi-Fi connection through a local router or a network connection using cell towers and/or satellites. This purchasing means provides a user access to the fuel 24 hours a day, 7 days a week.

The fueling unit 700 is adapted to connect to a mobile fueling tank 705. The fueling unit 700 comprises a tank attachment apparatus 750 that is secured to pump 701. The tank attachment apparatus 750 is used to connect and disconnect the mobile fueling tank 705 to and from the fueling unit 700. The tank attachment apparatus 750 comprises a coupler 752. Mobile fueling tank 705 further comprises an adapter 754 that is adapted to couple with coupler 752. Pump 701 may also comprise an emergency valve 780 to which tank attachment apparatus 750 is secured. Further, tank attachment apparatus 750 may comprise air line 751 to help remove any air within the liquid or fuel after the liquid or fuel has left tank 710.

Preferably, the coupler 752 and adapter 754 are Dry Break or API couplings which are dry disconnect couplings or dry break couplers that form a secure hose connection and allow for a spill-free disconnect. Dry Break couplings have become standard use to prevent spillage of petro-chemicals during the connection and disconnection of flowlines. Other coupling pairs may be used provided that the coupler 752 and adapter 754 are secured together in a way that prevents spillage of petro-chemicals during the connection and disconnection of flowlines. Common Dry Break and API couplings can be found in the market.

A mobile fueling tank 705 may be of a variety of mobile tanks including a mobile fuel tank, fuel trailers and fuel tankers. The mobile fueling tank 705 comprises a tank 710 that can hold a liquid. The mobile fueling tank 705 should be aboveground and not permanently secured to a location. Preferably, the mobile fueling tank 705 is a fuel tanker that can be easily connected and disconnected from the fueling unit as needed.

In this embodiment, tank 710 comprises a belly valve 712 and a vent 714. Vent 714 is designed to allow air into the tank 710 as the liquid or fuel is removed and keep fumes or toxic air from leaving the tank 710. Belly valve 712 is designed to release the liquid or fuel through the bottom of the tank 710. Belly valve 712 may also act as an emergency valve. Belly valves are common in the art. When the fuel is low in the tank 710, the mobile fueling tank 705 is disconnected from the fueling unit 700, taken to a refueling location, then returned to the fueling unit location and reconnected to the fueling unit 700.

Pump 701 may also comprise electrical outputs that connect the fueling unit 700 to a generator, electrical outlet, and/or electrical connectors on the mobile fueling tank.

Referring to FIG. 8, an assembly view of a self-service mobile fueling system is shown. The self-service mobile fueling unit 800 is shown along its side. In this embodiment, the fueling unit 800 comprises a dispenser or pump 801, a card reader 820, a filter 830, a fueling hose 845 and a pallet or platform 802.

The pump 801 is secured to the platform 802. Preferably a hose reel or holder 840 is secured to the platform 802 to hold the fueling hose 845. A filter 830 is secured to the pump 801 and fueling hose 845 to filter any particles from the gas that may be harmful to the mechanism being fueled. Preferably each part is secured to another part by way of bolts, rivets, screws, welding, or any other forms of fastening.

By having the pump 801, card reader 820, hose reel 840, and filter 830 directly or indirectly secured to platform 802, the fueling unit 800 becomes easily mobile as the platform 802 only needs to be moved from one location to another. The mobility of the fueling unit 800 allows it to be installed in various locations whether temporary, semi-permanent or permanent. Some examples of temporary locations may be a construction site, a fairground, or an event. Some semi-permanent or permanent locations may be a small charter airport, a marina, or a small rural town.

The platform 802 may be relocated by trailer, fork lift, cargo/freight, or any common means of transportation. The platform 801 may be simply placed in a location or temporarily secured to the ground by stakes, bolts, anchoring fasteners, or other forms of anchoring objects to the ground common in the art.

Card reader 820 allows the fueling unit 800 to be self-service. The self-service aspect of the invention is important as it allows the fueling unit 800 to be used anyway without a need for an attendant to be present. The card reader 820 may process transactions through a wired or wireless connection. A wireless connection may be a Wi-Fi connection through a local router or a network connection using cell towers and/or satellites. This purchasing means provides a user access to the fuel 24 hours a day, 8 days a week.

The fueling unit 800 is adapted to connect to a mobile fueling tank 805. The fueling unit 800 comprises a tank attachment apparatus 850 that is secured to pump 801. The tank attachment apparatus 850 is used to connect and disconnect the mobile fueling tank 805 to and from the fueling unit 800. The tank attachment apparatus 850 comprises a coupler 852. Mobile fueling tank 805 further comprises an adapter 858 that is adapted to couple with coupler 856. Pump 801 may also comprise an emergency valve 880 to which tank attachment apparatus 850 is secured. Further, tank attachment apparatus 850 may comprise air lines 851 and 853 that help remove any air within the liquid or fuel after the liquid or fuel has left tank 810.

Preferably, the coupler 856 and adapter 858 are Dry Break or API couplings which are dry disconnect couplings or dry break couplers that form a secure hose connection and allow for a spill-free disconnect. Dry Break couplings have become standard use to prevent spillage of petro-chemicals during the connection and disconnection of flowlines. Other coupling pairs may be used provided that the coupler 852 and adapter 854 are secured together in a way that prevents spillage of petro-chemicals during the connection and disconnection of flowlines. Common Dry Break and API couplings can be found in the market.

A mobile fueling tank 805 may be of a variety of mobile tanks including a mobile fuel tank, fuel trailers and fuel tankers. The mobile fueling tank 805 comprises a tank 810 that can hold a liquid. The mobile fueling tank 805 should be aboveground and not permanently secured to a location. Preferably, the mobile fueling tank 805 is a fuel tanker that can be easily connected and disconnected from the fueling unit as needed.

In this embodiment, tank 810 comprises a sub pump 816 and a vent 814. Vent 814 is designed to allow air into the tank 810 as the liquid or fuel is removed and keep fumes or toxic air from leaving the tank 810. Sub pump 816 is designed to pump the liquid or fuel from the inside of the tank 810 and pump it up through the top of the tank 810. Sub pump 816 resides inside tank 810 and is typically located near the bottom of tank 810. When the fuel is low in the tank 810, the mobile fueling tank 805 is disconnected from the fueling unit 800, taken to a refueling location, then returned to the fueling unit location and reconnected to the fueling unit 800.

Pump 801 may also comprise electrical outputs that connect the fueling unit 800 to a generator, electrical outlet, and/or electrical connectors on the mobile fueling tank.

An example of the application of the invention is as follows:

A small charter airplane needs to leave at 2 A.M. and requires fuel. At that time of night/morning, a fuel truck operator is usually not available. The airport may employ the invention to allow the plane owners/operators the convenience of refueling at any time of day without an attendant present.

Another example of the application of the invention is as follows:

A construction site may employ the invention. The invention provides a temporary fueling station on the actual construction site to refuel any construction vehicles as needed. Construction workers working during uncommon hours can continue using their vehicles without the inconvenience of requiring a fueling personnel to be present. Once the construction stop as a whole is finishing, the invention can be easily removed from the site without destruction of the site.

The system should not come under the present containment laws as it should not be considered as fuel in storage. For a large operation such as a high volume truck stop, the unloading time would be about the same as a fuel transport unit takes to unload into an underground storage tank. Such fuel transport trucks are typically not in containment while unloading fuel.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, I claim:

1. The method of fueling vehicles at one or more temporary fueling locations comprising the steps of:
providing at a first temporary fueling location a mobile above-ground tank of fuel being mounted on a trailer with a plurality of wheels and containing fuel to be dispensed at the first temporary fueling location, said mobile fuel tank formed of inner and outer fuel impervious walls, said mobile fuel tank being mounted on said trailer with said plurality of wheels so that the mobile fuel tank can be easily moved when fuel is consumed down to a certain predetermined level in the tank, said mobile fuel tank temporarily secured behind a tamper-proof fencing barrier at said first temporary fueling location, and said mobile fuel tank having fluid connectors and electrical connections;
securing the area around said mobile fuel tank at said first temporary fueling location using said tamper-proof fencing barrier to protect against theft or manipulation of fuel in said mobile fuel tank;
providing a portable self-serve metering and pumping unit at the first temporary fueling location, said metering and pumping unit placed on a platform adapted to be engaged by a lifting apparatus or vehicle for easy transport of the metering and pumping unit, said metering and pumping unit operable with a self-service computer-based card reader allowing for fuel dispensation without a fuel station attendant, said metering and pumping unit can be used with one or more secondary metering and pumping units at said first temporary fueling location so that multiple vehicles can be simultaneously serviced from said mobile fuel tank, said metering and pumping unit being portable so as to be moved independent of said mobile fuel tank to a second temporary fueling location, said metering and pumping unit having a filter to filter any particles from the fuel when dispensing fuel to the vehicle, said metering and pumping unit having fluid connectors for connecting the metering and pumping unit to the mobile fuel tank by a fluid line and having electrical connections to control fluid flow, said metering and pumping unit having a hydraulically powered pump to assist in the dispensing of fuel to the vehicle;
connecting the fluid connectors from the metering and pumping unit to the fluid connectors of the mobile fuel tank, said fluid connectors supporting the flow of fuel from said mobile fuel tank to said to said metering and pumping unit and having a dry break coupler that will prevent leakage or spillage of fuel during the connect and disconnect of fluid flow connectors;
connecting electrical connections between the mobile fuel tank and the self-serve metering and pumping unit to control the flow of fuel from the mobile fuel tank to the self-serve metering and pumping unit, said electrical connections controlling the hydraulic pump at the metering and pumping unit and an air pump associated with the mobile fuel tank;
pressurizing the mobile fuel tank with an air pump to assist in dispensing fuel from the mobile fuel tank;
activating the self-serve metering and pumping unit by authorization through a wired or wireless connection using the metering and pumping unit at the first temporary fueling location without the need for a fuel tank attendant, said wireless connection being a Wi-Fi connection through a local router or a network connection through a cell tower or satellite, and after fueling, using the activated metering and pumping unit to charge an amount of money for the fuel dispensed; and
dispensing fuel to one or more vehicles at the first temporary fueling location through the hydraulically powered pump without the need for a fuel station attendant.

2. The method of claim 1, further comprising the step of:
controlling venting of the mobile fuel tank when dispensing of fuel.

3. (canceled)

4. The method of claim 1, further comprising the steps of:
disconnecting the self-serve metering and pricing unit from the mobile fuel tank; and
relocating either the self-serve metering and pricing unit or the mobile fuel tank to a new temporary fueling location for use in fueling vehicles.

5. The method of claim 1, wherein said temporary fueling location is a construction site.

6. The method of claim 1, wherein said temporary fueling location is an airport.

7. The method of claim 1, wherein said authorization activating the self-serve metering and pumping unit is a credit card authorization.

8. The method of claim 1, wherein said dry break coupler is an API coupler.

9. A self-serve mobile fueling system, comprising:
an above-ground mobile fuel tank of fuel at a first temporary fueling location being mounted on a trailer with a plurality of wheels and having fuel to be dispensed at said first temporary fueling location, said mobile fuel tank formed of inner and outer fuel impervious walls, said mobile fuel tank being mounted on a trailer with a plurality of wheels so that the mobile fuel tank can be easily moved when fuel is consumed down to a certain predetermined level in the tank, said mobile fuel tank having fluid connectors and electrical connections;
a tamper-proof fencing barrier at the first temporary fueling location that temporarily secures said mobile fuel tank at said first temporary fueling location to protect against theft or manipulation of fuel in said mobile fuel tank;
an air pump associated with said mobile fuel tank, said air pump being used to pressurize said mobile fuel tank to assist in dispensing fuel from the mobile fuel tank;
a first portable self-serve metering and pumping unit at the first temporary fueling location, said metering and pumping unit placed on a platform, said platform adapted to be engaged by a lifting apparatus or vehicle for easy transport of the metering and pumping unit;
a computer-based card reader associated with said first metering and pumping unit, said self-service card reader allowing for fuel dispensation without a fuel station attendant, and said metering and pumping unit activated by authorization through a wired or wireless connection using the self-service card reader of the metering and pumping unit at the first temporary fueling location, said wireless connection being a Wi-Fi connection through a local router or a network connection through a cell tower or satellite, and said activated metering and pumping charging an amount of money for the fuel dispensed;
a second metering and pumping unit that can be used with said first metering and pumping units at said first temporary fueling location so that multiple vehicles can be simultaneously serviced from said mobile fuel tank, and said second metering and pumping unit being portable so as to be moved independent of said mobile fuel tank to a new second temporary fueling location;
said first and second metering and pumping units having a filter to filter any particles from the fuel when dispensing fuel to the vehicle, and said first and second metering and pumping units having fluid connectors for connecting the metering and pumping unit to the mobile fuel tank and electrical connections to control fluid flow, said first and second metering and pumping units having a hydraulically powered pump to assist in the dispensing of fuel to the vehicle;
said fluid connectors connecting the first or second metering and pumping unit to the mobile fuel tank to allow the transfer of the fuel from the mobile fuel tank to the first or second metering and pumping unit, said fluid connectors having a dry break coupler that will prevent leakage or spillage of fuel during the connect and disconnect of fluid flow connectors; and
said electrical connections connected between the mobile fuel tank and the first or second metering and pumping unit to control the flow of fuel from the mobile fuel tank to the first or second metering and pumping unit by controlling the hydraulic pump at the first or second metering and pumping unit and said air pump associated with the mobile fuel tank.

10. The system of claim 9, wherein said temporary fueling location is a construction site.

11. The system of claim 9, wherein said temporary fueling location is an airport.

12. The system of claim 9, wherein said authorization activating the self-serve metering and pumping unit is a credit card authorization.

13. The system of claim 9, wherein said dry break coupler is an API coupler.

14. The system of claim 9, further comprising a vent on said mobile fuel tank.

15. A self-serve mobile fueling system, comprising:
an above-ground mobile fuel tank of fuel at a first temporary fueling location being mounted on a trailer and having fuel to be dispensed at said first temporary fueling location, said mobile fuel tank formed of inner and outer fuel impervious walls, said mobile fuel tank being mounted on a trailer so that the mobile fuel tank can be easily moved when fuel is consumed down to a certain predetermined level in the tank, said mobile fuel tank having fluid connectors and electrical connections;
a tamper-proof fencing barrier at the first temporary fueling location that temporarily secures said mobile fuel tank at said first temporary fueling location to protect against theft or manipulation of fuel in said mobile fuel tank;
a first portable self-serve metering and pumping unit at the first temporary fueling location, said metering and pumping unit placed on a platform, said platform adapted to be engaged by a lifting apparatus or vehicle for easy transport of the metering and pumping unit;
a computer-based card reader associated with said first metering and pumping unit, said self-service card reader allowing for fuel dispensation without a fuel station attendant, and said metering and pumping unit activated by authorization through a wired or wireless connection using the self-service card reader of the metering and pumping unit at the first temporary fueling location, said wireless connection being a Wi-Fi connection through a local router or a network connection through a cell tower or satellite, and said activated metering and pumping charging an amount of money for the fuel dispensed;
said first metering and pumping unit having a filter to filter any particles from the fuel when dispensing fuel to the vehicle, and said first metering and pumping units having fluid connectors for connecting the metering and pumping unit to the mobile fuel tank and electrical connections to control fluid flow, said first metering and pumping units having a hydraulically powered pump to assist in the dispensing of fuel to the vehicle;
said fluid connectors connecting the first metering and pumping unit to the mobile fuel tank to allow the transfer of the fuel from the mobile fuel tank to the first metering and pumping unit, said fluid connectors having a dry break coupler that will prevent leakage or spillage of fuel during the connect and disconnect of fluid flow connectors; and
said electrical connections connected between the mobile fuel tank and the first metering and pumping unit to control the flow of fuel from the mobile fuel tank to the first metering and pumping unit by controlling the hydraulic pump at the first metering and pumping unit.

16. The system of claim 15, further comprising an air pump associated with said mobile fuel tank, said air pump being used to pressurize said mobile fuel tank to assist in dispensing fuel from the mobile fuel tank, said electrical connections controlling the air pump.

17. The system of claim 15, wherein said temporary fueling location is a construction site.

18. The system of claim 15, wherein said temporary fueling location is an airport.

19. The system of claim 15, wherein said authorization activating the self-serve metering and pumping unit is a credit card authorization.

20. The system of claim 15, wherein said dry break coupler is an API coupler.

21. The system of claim 15, further comprising a vent on said mobile fuel tank.
